(19) United States
(12) Patent Application Publication
(10) Pub. No.: US 2026/0219407 A1
(43) Pub. Date: Jul. 30, 2026

(54) CASCADED DEEP-LEARNING TECHNIQUES FOR GENERATING HIGH RESOLUTION HORIZON DATA

(71) Applicant: Schlumberger Technology Corporation, Sugar Land, TX (US)

(72) Inventors: Tao ZHAO, Houston, TX (US); Haibin DI, Houston, TX (US); Aria ABUBAKAR, Houston, TX (US)

(21) Appl. No.: 19/141,359

(22) PCT Filed: Jan. 12, 2024
(86) PCT No.: PCT/US2024/011478

§ 371 Date: Jun. 20, 2025

Related U.S. Application Data
(60) Provisional application No. 63/479,915, filed on Jan. 13, 2023.

(51) Int. Cl. G01V 1/30; G06N 3/0464

(52) U.S. Cl. CPC G01V 1/301; G06N 3/0464; G01V 2210/643

(57) ABSTRACT

The present disclosure describes techniques including receiving seismic data corresponding to a subsurface region. The techniques also include filtering the seismic data. The filtered seismic data corresponds to one or more depth ranges within the subsurface region. Further, the techniques include applying a first horizon model to the filtered seismic data. The first horizon model outputs a first set of horizon data having a first resolution indicating an expected location of a horizon within the one or more depth ranges. Even further, the techniques include applying a second horizon model to a portion of the seismic data centered based on the first set of horizon data. Further still, the techniques include generating a second set of horizon data based on the portion of seismic data, the first set of horizon data, and the second horizon model. The second set of horizon data has a higher resolution than the first resolution.

### CROSS-REFERENCE TO RELATED APPLICATIONS

This application claims priority to U.S. Provisional Patent Application No. 63/479,915, filed on Jan. 13, 2023, which is incorporated herein by reference in its entirety.

### BACKGROUND

Determining site characteristics across an area of interest (AOI) may be challenging. The AOI may have complex geological structures and obtaining useable lithological data from the rock layers of the ocean floor may involve employing certain specialty testing methods that may be inefficient with respect to time and costs (e.g., financial, processing resources). That is, sediment and rock layer information may be obtained from one or more rock layers along the seabed across an AOI to determine the feasibility of foundation construction. Because of the number of tests that would be required to obtain an accurate representation of rock layers for the AOI, this process may be time consuming and costly to entities interested in building or securing equipment in an AOI.

With traditional automatic horizon tracking tools, for a given seismic trace, candidate horizon picks are searched within a temporal (vertical) window defined by the adjacent traces where horizon picks exist. One challenge in solving horizon interpretation with DL is defining the 2D analysis window encapsulating the horizon picks. For structurally complex regions of interest (ROIs) where a horizon varies significantly vertically, a large vertical window size is needed, ideally spanning the entire seismic trace, to capture the complete horizon. Each recorded seismic trace from the ultra-high resolution (UHR) seismic data, which are commonly used in the wind energy industry, contains thousands of data samples. Given thousands of samples per trace, it is infeasible to feed in 2D image patches covering the entire seismic record length into a DL model. Currently, it is challenging perform automatic/semiautomatic seismic horizon interpretation on multiple 2D seismic lines simultaneously-it has to be done line by line which is time consuming. Also, the current horizon tracking tool doesn't work well on the UHR seismic data commonly used in the wind energy industry, which in general have poorer quality than data used in the oil and gas industry. As such there is a need for automatic horizon tracking.

### SUMMARY

A summary of some embodiments disclosed herein is set forth below. It should be understood that these aspects are presented merely to provide the reader with a brief summary of these embodiments and that these aspects are not intended to limit the scope of this disclosure. Indeed, this disclosure may encompass a variety of aspects that may not be set forth below.

Embodiments of the present disclosure includes a method. The method includes receiving seismic data corresponding to a subsurface region of interest (ROI). The method also includes filtering the seismic data to generate filtered seismic data. The filtered seismic data may correspond to one or more depth ranges within the subsurface ROI. Further, the method includes applying a first horizon model to the filtered seismic data, wherein the first horizon model is configured to output first set of horizon data having a first resolution indicating an expected location of a horizon within the one or more depth ranges. The method may include applying a second horizon model to a portion of the seismic data centered based on the first set of horizon data. The second horizon model comprises a higher resolution than the first horizon model. The method may include generating a second set of horizon data based on the portion of seismic data, the first set of horizon data, and the second horizon model, wherein the second set of horizon data comprises a higher resolution than the first set of horizon data.

In an embodiment of the present disclosure, a method of includes receiving unfiltered seismic data corresponding to a subsurface region of interest (ROI), filtering the unfiltered seismic data to generate filtered seismic data, retrieving a horizon label as a two-dimensional (2D) mask, training a first horizon deep learning model utilizing the filtered seismic data and the horizon label as 2D mask, the first horizon deep learning model has a first output having a first resolution, and applying a second horizon deep learning model to a horizon label as 1D mask and a portion of the unfiltered seismic data. The second horizon deep learning model may have a second output that is one or more specific horizon locations having a second resolution and the second resolution may have higher resolution than the first resolution. The second horizon deep learning model may be a segmentation convolutional neural network or a regression convolutional neural network. The method may also include displaying one or both of the first output and the second output and performing a worksite action in response to one or both of the first output and the second output. The worksite action may include generating and transmitting a signal that causes a physical action to occur at the worksite that includes the subsurface ROI and the physical action may include selecting a specific worksite.

An embodiment of the method may include filtered seismic data that is a vertically resampled version of the unfiltered seismic data for the ROI. The 2D mask or the 1D mask may be received from a user or a data storage component. The first output of the method may be a 2D probability map of an approximate location of one or more horizon picks. The portion of the unfiltered seismic data may be within a threshold distance of the approximate location of the one or more horizon picks. The second resolution may be identical to a resolution of the unfiltered seismic data. The second output may include a plurality of one-dimensional vector outputs representing horizon locations.

Another embodiment of the disclosed method includes receiving unfiltered seismic data corresponding to a subsurface region of interest (ROI), filtering the unfiltered seismic data to generate filtered seismic data, retrieving a horizon label as a two-dimensional (2D) mask, training a first horizon deep learning model utilizing the filtered seismic data and the horizon label as 2D mask. The trained first horizon deep learning model has a first output that is a 2D probability map having a first resolution and providing an approximate location of one or more horizon picks. The first horizon deep learning model is an image segmentation convolutional neural network. Another step in the method may be applying a second horizon deep learning model to a horizon label as 1D mask and a portion of the unfiltered seismic data, wherein the second horizon deep learning model has a second output that is one or more specific horizon locations having a second resolution. The method also includes displaying one or both of the first output and the second output and performing a worksite action in response to one or both of the first output and the second output. The worksite action may include generating and transmitting a signal that causes a physical action to occur at the worksite that includes the subsurface ROI. The physical action may include selecting a specific worksite. The second resolution may be higher resolution than the first resolution and the second horizon deep learning model may be one of a segmentation convolutional neural network and a regression convolutional neural network.

In any embodiment, the filtered seismic data may be a vertically resampled version of the unfiltered seismic data for the ROI. The 2D mask or 1D mask may be received from a user or a data storage component. The portion of the unfiltered seismic data may be within a threshold distance of the approximate location of the one or more horizon picks. The second resolution may be identical to a resolution of the unfiltered seismic data. The output may include a plurality of one-dimensional vector outputs representing horizon locations.

In a further embodiment, a method includes receiving unfiltered seismic data corresponding to a subsurface region of interest (ROI), filtering the unfiltered seismic data to generate filtered seismic data, the filtered seismic data may be a vertically resampled version of the unfiltered seismic data for the ROI, retrieving a horizon label as a two-dimensional (2D) mask from a user or a data storage component, training a first horizon deep learning model utilizing the filtered seismic data and the horizon label as 2D mask. The trained first horizon deep learning model has a first output that is a 2D probability map having a first resolution, the 2D probability map provides an approximate location of one or more horizon picks, and the first horizon deep learning model is an image segmentation convolutional neural network. The method may also include retrieving a horizon label as a one-dimensional (1D) mask from the user or data storage component, applying a second horizon deep learning model to the horizon label as 1D mask and a portion of the unfiltered seismic data that is within a threshold distance of the approximate location of the one or more horizon picks. The second horizon deep learning model may have a second output that is one or more specific horizon locations having a second resolution, the second resolution may be of higher resolution than the first resolution, the second horizon deep learning model may be one of a segmentation convolutional neural network and a regression convolutional neural network, the second resolution may be identical to an unfiltered seismic data resolution, and the second output may include a plurality of one-dimensional vector outputs representing horizon locations. The method may also include displaying one or both of the first output and the second output, and performing a worksite action in response to one or both of the first output and the second output. The worksite action may include generating and transmitting a signal that causes a physical action to occur at the worksite that includes the subsurface ROI, and wherein the physical action includes selecting a specific worksite.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWING

These and other features, aspects, and advantages of the present disclosure will become better understood when the following detailed description is read with reference to the accompanying drawings in which like characters represent like parts throughout the drawings, wherein:

FIG. 1 illustrates a schematic view, partially in cross section, of a system for determining site characterization properties of an Area of Interest (AOI), in accordance with an aspect of the present disclosure.

FIG. 2 illustrates a block diagram of a site characterization system and other connected components, in accordance with an aspect of the present disclosure.

FIG. 3 illustrates a process flow diagram of a method for determining site characterization properties of an AOI, in accordance with an aspect of the present disclosure.

FIG. 4 illustrates a process flow diagram of an alternative, optimized method for determining site characterization properties of an AOI, in accordance with an aspect of the present disclosure.

FIG. 5A illustrates an overhead plan view showing all 2D seismic lines within a geographic region with highlighted 2D seismic lines on which horizon labels used for training the deep learning models are available.

FIG. 5B illustrates a cross-sectional view of one 2D seismic line showing seismic events representing sedimentary and rock layers in an AOI with lines representing horizon locations between layers.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

The present disclosure relates generally to generating site characterizations for an Area of Interest (AOI) based on predicted data. More specifically, the present disclosure relates to determining foundational characteristics of the sediment and rock layer properties to help facilitate the construction of different equipment, such as offshore windfarms and the like.

Offshore wind farms can generate a significant amount of power, as compared to their onshore counterparts. However, challenges remain in characterizing potential sites in which offshore windfarms may be constructed. Indeed, current site characterization methodologies may involve taking sediment information from various rock layers along a seabed at several points in an AOI, interpreting the sediment information through certain geostatistical algorithms, and making predictions about the sediment, piling foundations, and other site characteristics of the seabed to determine the feasibility of constructing an offshore wind farm at the respective site.

One type of characterization of potential sites involves interpreting seismic data to determine horizons corresponding to lithography changes and/or subsurface structures, which may be used to generate a subsurface model or subterranean model. As referred to herein, a “horizon” refers to an interface between two rock layers having different properties, such as seismic velocity, density, porosity, fluid content, or a combination thereof. Certain conventional techniques for determining horizons may involve selecting or labeling a two-dimensional (2D) area or window within seismic data (e.g., a seismic trace). However, it may be difficult and/or require a large amount of computational resources to determine a horizon for structurally complex ROIs, such as regions where a horizon may vary vertically.

Accordingly, the presented disclosure is directed to cascaded deep-learning techniques for generating a subsurface model. In general, the cascaded deep-learning techniques may include filtering seismic data to generate filtered seismic data (e.g., decimated seismic data) and determining an estimated horizon label using the filtered seismic data, a model (e.g., a horizon label model as a two-dimensional mask) an expected location (e.g., a depth or distance from a surface) and/or location range of a potential horizon location. In some embodiments, the techniques may then generate a first model representative of the estimated horizon label within the seismic data. For example, the first model can be a 2D image segmentation convolutional neural network (CNN).

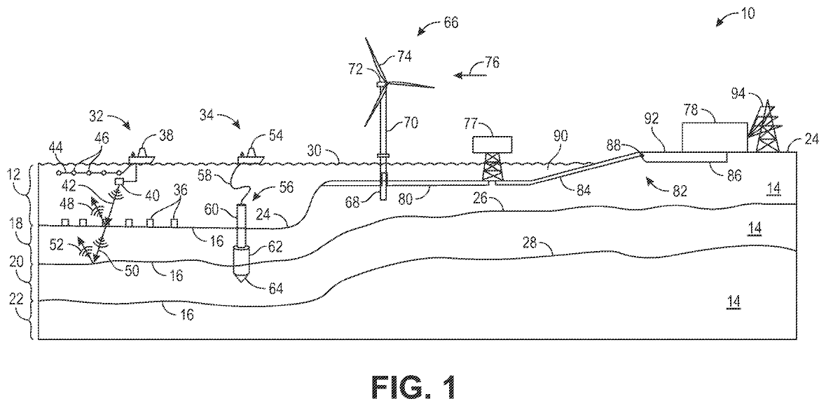

After generating the first model, which may provide a lower resolution representation (e.g., lower than the resolution of the acquired seismic data), the cascaded deep-learning techniques may include determining a horizon location using the unfiltered seismic data (e.g., undecimated seismic data) and the first model (e.g., low-resolution horizon). In some embodiments, the techniques may include utilizing a subset of the unfiltered seismic data that generally corresponds to (e.g., is within a threshold distance of) the estimated horizon label. In some embodiments, the subset of the unfiltered seismic data may be used with the first model and a horizon label model as a one-dimensional series to generate a second model indicative of the horizon location within the undecimated seismic data. In some cases, the second model can be a convolutional neural network (CNN). By utilizing the first model indicative of the estimated horizon label determined using filtered seismic data, a higher resolution model of the estimated horizon of a subsurface ROI may be determined more efficiently and quickly as compared to conventional techniques. Further, the horizon location may be determined at substantially the same resolution as the original, unfiltered seismic data. It should be noted that although the discussion above generally relates to a subsurface ROI of a windfarm, the disclosed cascaded deep-learning techniques may also be applied to seismic interpretation of other types of subsurface ROIs. The cascaded deep-learning techniques described herein can accelerate seismic horizon interpretation process when dealing with seismic data (e.g., 2D seismic lines). In some cases, the seismic horizon interpretation process can be performed simultaneously. Additional details related to implementing the cascaded deep-learning techniques will be discussed below with reference to FIGS. 1-5A, 5B.

By way of introduction, FIG. 1 illustrates a schematic view of system 10 for determining site characterization properties of an Area of Interest (AOI). Referring to FIG. 1, the system 10 may include a body of water 12 as well as one or more rock layers 14. The one or more rock layers 14 may be distinct from one another and one or more rock layer surfaces 16 may be used to identify the rock layers 14. In the illustrated embodiment, the AOI includes a first rock layer 18, a second rock layer 20, and a third rock layer 22. The one or more rock layers 14 and the body of water 12 are separated in the illustrated embodiment by the one or more rock layer surfaces 16. The body of water 12 and the first rock layer 18 are separated via the first rock layer surface 24, the first rock layer 18 and the second rock layer 20 are separated via the second rock layer surface 26, and the second rock layer 20 and the third rock layer 22 are separated via the third rock layer surface 28. The one or more rock layer surfaces 16 may be defined at certain depths within the of the one or more rock layers 14 that correspond to classifications of sediment and lithological data. For example, the first rock layer 18 may be classified by the majority of the sediment being shale based on lithological data. The second rock layer 20 may be classified by the majority of the sediment being limestone based on lithological data. In some embodiments, the second rock layer surface 26 may be associated with the depth at which the sediment transitions from majority-shale to majority-limestone. Additionally, the body of water 12 will have a water surface 30. It should be appreciated that the illustrated embodiment in FIG. 1 may not be to scale and that the following described elements may not be oriented in the same order in another embodiment of the system 10.

In some embodiments, the one or more rock layers 14 may be relatively lithologically distinct from one another. The one or more rock layers 14 may be sedimentary rock layers related to a time period in which the respective rock layer was formed. In other embodiments, the one or more rock layers 14 may be relatively lithologically similar to one another. Distinctions between the one or more rock layers 14 may be made by a rock layer property that is not associated with the physical properties of the one or more rock layers 14.

Keeping the foregoing in mind, the AOI depicted in the system 10 may be the site of testing procedures in order to determine lithological and seismic data for the one or more rock layers 14. These testing procedures may include marine seismic data surveys 32, cone penetrative test (CPT) surveys 34, and the like. In addition, the testing procedures and data analysis described herein may also be performed using seismic data acquired via land seismic data surveys and the like.

Referring first to the marine seismic data surveys 32, the marine seismic data surveys 32 may include ocean bottom node (OBN) measurement by employing multiple OBNs 36 on the first rock layer surface 24. The OBNs 36 may be deployed (e.g., using remotely operated vehicles (ROVs)) to selected locations and form a certain geometry (e.g., an OBN patch with 200 meters by 200 meters grid size). Each of the OBNs 36 may include one or more OBN sensors. The OBN sensors may include one or more geophones (e.g., three-component geophones). In some embodiment, the OBN sensors may also include hydrophones.

In addition, the marine seismic data surveys 32 may employ one or more seismic source vessels 38. For example, a seismic source vessel 38 towing a seismic source 40 may be used to create seismic waves 42 propagating downward into the one or more rock layers 14. Each of the seismic sources 40 may include one or more source arrays and each source array may include a certain number of sources (e.g., air guns, marine vibrators, etc.).

The marine seismic data survey 32 may also include streamer measurement by employing multiple seismic streamers 44 traversing the water. For example, the seismic source vessel 38 may tow multiple (e.g., two, four, six, eight, or ten) seismic streamers 44 along one sail line, and the seismic source vessel 38 may tow multiple seismic streamers 44 along another sail line. The streamer measurement may be acquired independently or simultaneously with the OBN measurements using shots fired by the seismic sources 40. Each of the seismic streamers 44 may include multiple streamer sensors 46. The streamer sensors 46 may include hydrophones or other suitable sensors that create electrical signals in response to water pressure changes caused by reflected seismic waves that arrive to the hydrophones.

During the marine seismic data survey 32, the seismic source 40 may be activated to generate seismic waves 42 traveling downward into the one or more rock layers 14. When the seismic waves 42 arrives at the first rock layer surface 24, a portion of seismic energy contained in the seismic waves 42 is reflected by the first rock layer surface 24. Reflected waves 48 travel upward and arrive at different sensors, such as the streamer sensors 46, where the reflected waves 48 are measured by corresponding sensors. Another portion of the seismic energy contained in transmitted seismic waves 50 propagated through the first rock layer surface 24 into the second rock layer 20. A portion of seismic energy contained in the transmitted seismic waves 50 is reflected by the second rock layer surface 26. Reflected waves 52 travel upward and arrive at the different sensors, such as the streamer sensors 46, where the reflected waves 52 are measured by the corresponding sensors.

In some embodiments, the transmitted seismic waves 50 may include primary waves (p-waves) and secondary waves (s-waves). The p-waves may transmit through the one or more rock layers 14 at a faster speed than the s-waves. In this way, the p-waves may be the first seismic waves to reflect off of the next lowest rock layer surface and arrive at the different sensors, such as the streamer sensors 46. In some embodiments, the sensors may be designated as p-wave sensors and as s-wave sensors, in which the p-wave sensors are disposed to measure data from the reflected p-waves, and the s-wave sensors are disposed to measure data from the reflected s-waves.

The portion of the seismic energy that is transmitted through the rock layer as opposed to being reflected from the rock layer may vary between embodiments. For example, if the first rock layer 18 is relatively reflective to seismic waves compared to the body of water 12, a larger portion of the seismic energy may reflect off of the first rock layer surface 24 as the reflected waves 48. Conversely, if the second rock layer 20 is relatively transmissive to seismic waves compared to the first rock layer 18, a larger portion of the seismic energy may transmit through the second rock layer surface 26 as the transmitted seismic waves 50. In some embodiments, the transmissivity and reflectivity of the one or more rock layers 14 may limit the depth of which the seismic energy is able to be transmitted. For example, if the one or more rock layers 14 are relatively transmissive to the seismic waves, the seismic energy may reach a deeper rock layer than if the one or more rock layers 14 are relatively reflective to the seismic waves.

In some embodiments, a marine seismic source may be used to generate an acoustic signal. For example, the marine seismic source may generate the acoustic signal by discharging an electrical pulse. At least in some instances, the acoustic signal generated by the marine seismic source (e.g., spark source) may result in data that is relatively higher as compared to certain other acoustic signal sources.

It should be noted that the elements described above with regard to the marine seismic data survey 32 are exemplary elements. For instance, some embodiments of the marine seismic data survey 32 may include additional or fewer elements than those shown. In some embodiments, the marine seismic data survey 32 may include a different number of seismic source vessels 38. In some embodiments, separated receiver vessels may be used to tow the streamers.

With regard to the CPT survey 34, one or more CPT vessels 54 may be used to acquire CPT data. For example, a CPT vessel 54 may provide power to an instrumented cone 56 in the one or more rock layers 14 via a CPT cable 58. The instrumented cone 56 may include a rod 60 that provides a force that pushes the instrumented cone 56 into the sediment. The instrumented cone 56 may also include a friction sleeve 62. The friction sleeve 62 may quantify an amount of friction experienced by the instrumented cone 56 as the instrumented cone 56 passes through a distinct rock layer. In this way, the friction sleeve 62 can provide valuable information as to the lithological characteristics of the one or more rock layers 14. The instrumented cone 56 may also include a cone tip 64 that may lower the required amount of force supplied via the rod 60 and increase the depth at which the friction sleeve 62 may take lithological measurements.

By way of operation of the CPT survey 34, the CPT vessel 54 may position itself above a specific location in the AOI that is of interest to an entity. The CPT vessel 54 may deploy the instrumented cone 56 to be directed with the cone tip 64 in contact with the first rock layer surface 24 and the rod 60 and friction sleeve 62 extending upwards. The CPT vessel 54 may include a power source that generates a force in the rod 60 via the CPT cable 58 that pushes the instrumented cone 56 through the first rock layer surface 24 and into the first rock layer 18. The rod 60 continues to provide a force that pushes the instrumented cone 56 further downward at a continuous speed. In this way, the friction sleeve 62 may determine the amount of friction caused by the surrounding rock layers with the speed of the instrumented cone 56 acting as a controlled variable. The friction sleeve 62 may continue recording the friction as the instrumented cone 56 is pushed through the first rock layer 18 and the cone tip 64 makes contact with the second rock layer surface 26. The instrumented cone 56 may continue downward through the second rock layer surface 26 and into the second rock layer 20. The friction sleeve 62 may continue recording the amount of friction as the instrumented cone 56 passes between rock layers. If the one or more rock layers 14 are lithologically distinct, the friction sleeve 62 may record a change in average friction as the instrumented cone 56 passes between them. In this way, the instrumented cone 56 may identify the depth at which the first rock layer 18 transitions to the second rock layer 20 as well as lithological data with regards to each distinct rock layer.

It should be noted that the elements described above with regard to the CPT survey 34 are exemplary elements. For instance, some embodiments of the CPT survey 34 may include additional or fewer elements than those shown. In some embodiments, the CPT survey 34 may include a different number of CPT vessels 54. In some embodiments, each CPT vessel 54 may have a different number of CPT cables 58 leading to one or more instrumented cones 56 at different specific locations. In some embodiments, the CPT cables 58 may also communicate data (e.g., instructional commands, lithological data, depth data, speed data, etc.) between the instrumented cone 56 and the CPT vessel 54.

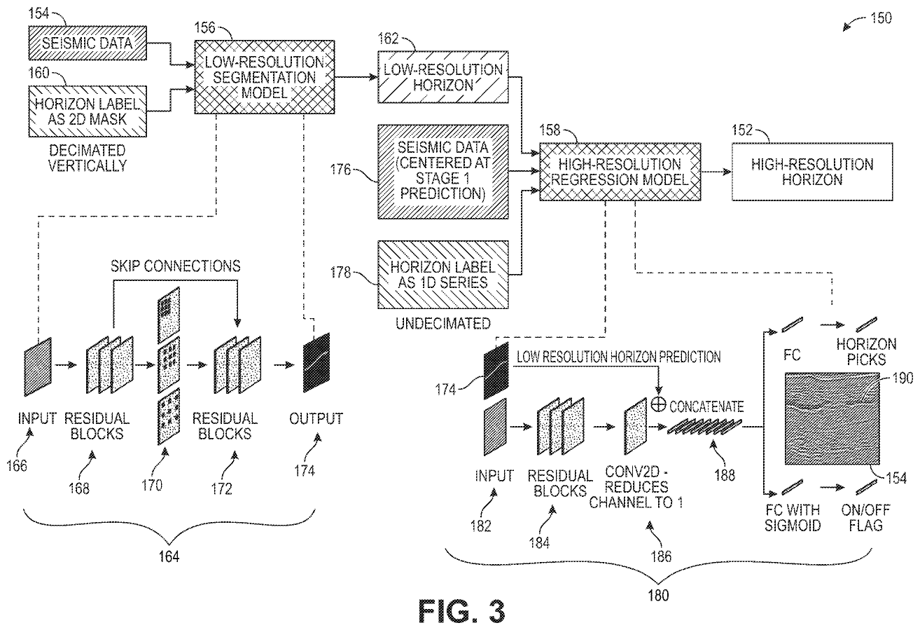

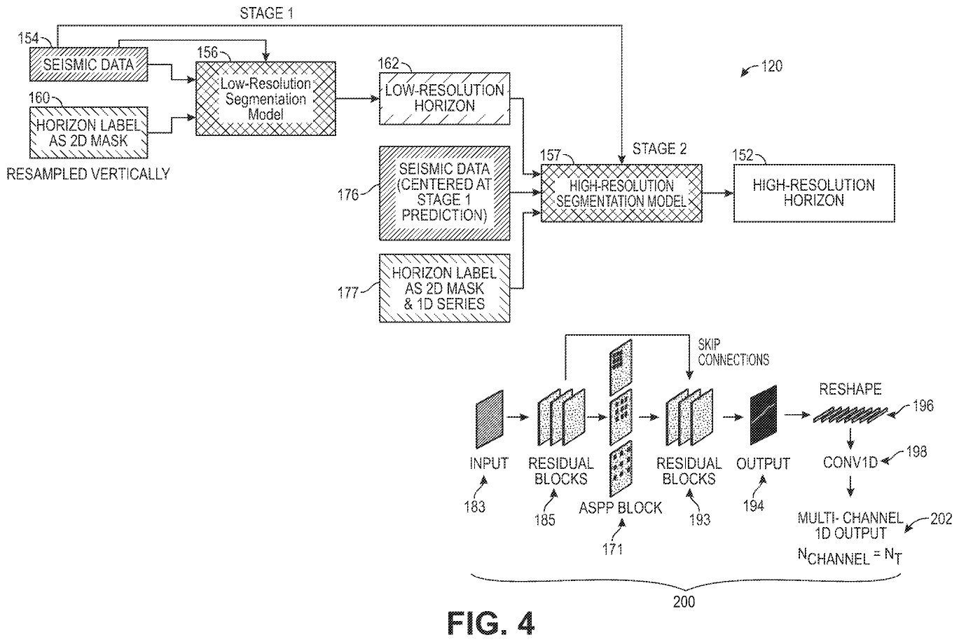

In some embodiments, the AOI may be the site of an offshore wind farm. Data collected from the marine seismic data survey 32 and the CPT survey 34 may influence whether or not the AOI is chosen to for the site of the offshore wind farm. In some embodiments, the collected data may be used as an input for a method for site characterization as will be detailed below with reference to FIGS. 3 and 4. In some embodiments, the method for site characterization may generate site characterization properties (e.g., rock strength, erosion patterns, water corrosiveness, water current velocity, etc.) that indicate whether the AOI is suitable for an offshore wind farm.

The offshore wind farm may include one or more wind turbines 66 situated in the AOI and held at a set location in the AOI within some proximity to the one or more rock layers 14. The wind turbine 66 may include a turbine foundation 68, which is embedded within the one or more rock layers 14, as well as a support tower 70 leading from the turbine foundation 68 to a turbine generator 72. The turbine generator 72 is coupled to one or more turbine blades 74 that may rotate as the turbine blades 74 receive an air flow 76 across them. In this way, the wind turbine 66 may generate power from the air flow 76.

The turbine foundation 68 may be deep enough to extend throughout the one or more rock layers 14. The illustrated embodiment depicts the turbine foundation 68 residing within the first rock layer 18, but in some other embodiment, the turbine foundation 68 may extend into the second rock layer 20 and/or into the third rock layer 22.

The stability granted to the wind turbine 66 through the turbine foundation 68 may be useful for determining the expected lifespan of the wind turbine 66. As mentioned earlier, the wind turbine 66 with the turbine foundation 68 built in one or more rock layers 14 with a lower relative rock strength may not be operational for as long as a wind turbine 66 with the turbine foundation 68 built in a one or more rock layers 14 with a higher relative rock strength. For example, the illustrated embodiment depicts a wind turbine 66 with a monopole-style turbine foundation 68 (e.g., a single support tower extending from the generator into the rock layers). As the turbine blades 74 spin when an air flow is directed across them, the rotating turbine blades 74 create a physical moment in the turbine foundation 68. With a relatively strong turbine foundation 68, the physical moment may not cause the support tower 70 to rotate in the direction of the created moment.

The offshore wind farm may include an offshore substation 77. The offshore substation 77 may collect generated power from the one or more wind turbines 66 before exporting the collected power to an onshore substation 78. The offshore substation 77 may also have foundational support built into the one or more rock layers 14. The offshore substation 77 and the one or more wind turbines 66 may be in electrical communication via an offshore cable array 80. The offshore cable array 80 may be distributed throughout the AOI and may be embedded within the one or more rock layers 14. In this way, the offshore cable array 80 and the offshore substation 77 may both be safely secured with a lower risk of either one becoming loose and affected by the ocean currents. The onshore substation 78 and the offshore substation 77 may be in electrical communication via an export cable array 82. The export cable array 82 may include an offshore export cable 84, an onshore export cable 86, and a cable landing point 88. The offshore export cable 84 may be in electrical communication with the offshore substation 77 and may be embedded within the one or more rock layers 14 of the transition zone 90 between the body of water 12 and the shore 92. After reaching the shore 92, the offshore export cable 84 may reach a cable landing point 88 that is in electrical communication with the onshore substation 78 via the onshore export cable 86. The onshore export cable 86 may also be embedded within the one or more rock layers 14. In this way, the offshore substation 77 may transport the collected power from the one or more wind turbines 66 to the onshore substation 78. The onshore substation 78 may then distribute the collected power out of the AOI via one or more power lines 94.

Offshore wind farms are able to generate large amounts of power from the air flow 76 above the body of water surface 30 and distribute that power out of the AOI to be used by entities outside of the AOI. Across the offshore wind farm, multiple elements (e.g., the turbine foundation 68, the offshore array cable, the offshore substation 77, the offshore export cable 84, the onshore export cable 86) rely upon known site characterization properties associated with the ocean floor sediment and the one or more rock layers 14 across the AOI (e.g., below the body of water, in the transition zone, on shore).

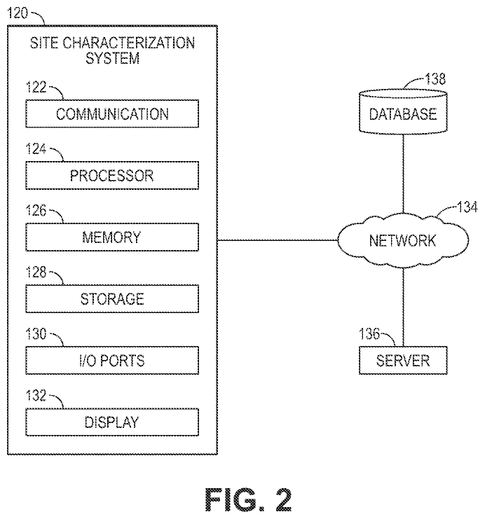

With the foregoing in mind, the data acquired via the marine seismic data survey 32, the CPT survey 34, and other data sources may be used to determine the site characterization properties of the AOI. Referring now to FIG. 2, the site characterization system 120 may include any suitable computing device, cloud-computing device, or the like and may include various components to perform various analysis operations related to performing the embodiments described herein. By way of example, the site characterization system 120 may include a communication component 122, a processor 124, a memory 126, a storage component 128, input/output (I/O) ports 130, a display 132, and the like. The communication component 122 may be a wireless or wired communication component that may facilitate communication between different monitoring systems, gateway communication devices, various control systems, and the like. The processor 124 may be any type of computer processor (e.g., multi-core) or microprocessor capable of executing computer-executable code. The memory 126 and the storage component 128 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 124 to perform the presently disclosed techniques. The memory 126 and the storage component 128 may also be used to store data received via the I/O ports 130, data analyzed by the processor 124, or the like.

The I/O ports 130 may be interfaces that may couple to various types of I/O modules such as sensors, programmable logic controllers (PLC), and other types of equipment. For example, the I/O ports 130 may serve as an interface to pressure sensors, flow sensors, temperature sensors, seismic sensors, friction sensors, and the like. As such, the site characterization system 120 may receive lithological or seismic data associated with the one or more rock layers 14 via the I/O ports 130. The I/O ports 130 may also serve as an interface to enable the site characterization system 120 to connect and communicate with surface instrumentation, servers, and the like.

The display 132 may include any type of electronic display such as a liquid crystal display, a light-emitting-diode display, and the like. As such, data acquired via the I/O ports and/or data analyzed by the processor 124 may be presented on the display 132, such that the site characterization system 120 may present site characterization properties for the AOI for view. In certain embodiments, the display 132 may be a touch screen display or any other type of display capable of receiving inputs from an operator. Although the site characterization system 120 is described as including the components presented in FIG. 2, the site characterization system 120 should not be limited to including the components listed in FIG. 2. Indeed, the site characterization system 120 may include additional or fewer components than described above.

It should also be noted that for the sake of modularity and flexibility with regard to both the size and specifications of generating site characterization properties, the site characterization system 120 may be implemented over a web application with back-end and front-end components. In this scheme, the back-end component may be responsible for handling certain predictive algorithms and modeling techniques, while the front-end component may be used to set a geological process model specifications and parameters from a user's perspective as detailed further below. The communication between the front-end component and back-end component of the site characterization system 120 may involve communications over any suitable network 134.

The site characterization system 120 may also include one or more remote servers, as shown in the illustrated embodiment as a server 136. The server 136 may communicate with the site characterization system 120 via the network 134. In some embodiments, the site characterization system 120 may employ the server 136 to assist the site characterization system 120 in apply modeling techniques and algorithms to the received data and to reduce computing power required of the site characterization system 120. Similarly, the site characterization system 120 may also include one or more databases, as shown in the illustrated embodiment as a database 138. The database 138 may receive, send, and store relevant data to the site characterization system 120. For example, the first database may store a seismic dataset based on the results of a marine seismic data survey 32. The site characterization system 120 may request the seismic dataset and receive the seismic dataset at a time after the seismic dataset had been recorded and sent to the database 138.

With the foregoing in mind, the site characterization system 120 may implement a method to generate site characterization properties across an AOI. For instance, the site characterization system 120 may receive sediment and rock layer data associated with specific locations in the AOI. The sediment and rock layer data may be obtained through one or more testing methods (e.g., marine seismic data survey 32, CPT survey 34, etc.). The site characterization system 120 may apply machine learning algorithms to the seismic data to determine seismic horizons within the seismic data. The resulting analysis may include site characterization properties for view via the display 132 and may be used by various entities to determine the feasibility and plan the construction of foundations for various types of equipment, such as the offshore windfarm.

With this in mind, FIG. 3 illustrates a data flow diagram 150 for generating a high-resolution horizon 152 by utilizing cascaded deep-learning techniques. The data flow diagram 150 represents techniques that may be performed by the processor 124, or any suitable processor(s) (e.g., at least one processor). In general, the cascaded deep-learning techniques may include using seismic data 154 to train a low-resolution segmentation model 156 (e.g., low-resolution horizon model) and a high-resolution regression model 158 (e.g., high-resolution horizon model). The low-resolution segmentation model 156 and/or the high-resolution regression model 158 may each be trained on the seismic data 154 (e.g., a portion of the seismic data 154) as described in further detail below. In some embodiments, the training and/or implementation of the low-resolution segmentation model 156 and/or the high-resolution regression model 158 may be performed via one or more cloud computing devices and/or one or more physical computing devices, such as the processor 124. In some embodiments, the low-resolution segmentation model 156 and/or the high-resolution regression model 158 may be trained in a supervised learning fashion, trained individually, or the like.

The present embodiments for performing the techniques described in the flow diagram 150 will be discussed as being performed by the site characterization system 120. However, it should be understood that the techniques described in the flow diagram 150 may be performed by any suitable computing device.

Referring now to FIG. 3, in some embodiments, the site characterization system 120 may receive seismic data 154 and a horizon label as two-dimensional (2D) mask 160 (e.g., across x-z plane) to apply to a low-resolution segmentation model 156. In general, the low-resolution segmentation model 156 may identify a low-resolution horizon 162 representing a probability or likelihood of a horizon being at one or more locations or depths within a subsurface region (e.g., including the rock layers 14). As described herein, the seismic data 154 may include one or more seismic traces (e.g., seismic trace data) indicating measured seismic waves reflected due to seismic waves incident on horizons between rock layers 14. The horizon label as 2D mask 160 may include data indicating features in the reflected waves (e.g., reflected wave 48 as described in FIG. 1) that correspond to horizons. For example, the horizon label as 2D mask 160 may include labels, tags, or otherwise data. In some embodiments, the horizon label as 2D mask 160 may be provided by a user. In some embodiments, the horizon label as 2D mask 160 may be retrieved from a suitable storage component (e.g., cloud storage component or otherwise) that is communicatively coupled or otherwise accessible by the processor 124. In any case, the low-resolution segmentation model 156 may be trained based on the filtered seismic data 154 and the horizon label as 2D mask 160 to identify an expected location (e.g., a depth or distance from a surface) and/or location range of a potential horizon using the filtered seismic data 154, as described in more detail below.

In some embodiments, the site characterization system 120 may decimate or filter the seismic data 154 prior to applying the low-resolution segmentation model 156 to the seismic data 154. In general, decimating (e.g., vertically decimating) the seismic data 154 may include reducing the size of the seismic data 154 by taking every nth sample of the seismic data 154 or otherwise filtering seismic data except every nth sample of the seismic data 154. For example, seismic data 154 including 1000 increments corresponding to a resolution along the depth of the subsurface ROI may be vertically decimated by a factor of 10. As such, the increments (e.g., packets as described with respect to the input 166 described below) of the seismic data 154 may be reduced to 100 (e.g., retaining every 10^{th}) sample, which may make the size of the data more manageable for processing. Accordingly, decimating (e.g., filtering) the seismic data 154 may produce relatively lower resolution seismic data. The horizon label as mask 160 may include a relative index of the horizon. As such, the decimated seismic data 154 may still retain contextual information associated with the horizon label as mask 160 (e.g., the probability or likelihood of a horizon existing at a particular location within a subsurface ROI). Although the example above described decimating by a factor of 10, it should be noted that the seismic data 154 may be decimated by any suitable factor, such as 2, 5, 10, 15, 20, and so on, in order to result in filtered seismic data.

After receiving the seismic data 154 and the horizon label as a mask 160, the site characterization system 120 may train or generate the low-resolution segmentation model 156 using these inputs. An example of the operations performed during the training and/or operation of the low-resolution segmentation model 156 are shown in inset 164. The low-resolution segmentation model 156 may include a deep learning model and may be referred to as a first horizon deep learning model.

In some embodiments, the low-resolution segmentation model 156 may be a machine learning model. As shown, an input 166 (i.e., a portion or packet of the seismic data 154) may be provided to one or more layers 168 (e.g., ‘residual blocks’), 170 (e.g., ‘atrous spatial pyramid pooling (ASPP) blocks’), and 172 (e.g., ‘residual blocks’). In some embodiments, the one or more layers 168, 170, and 172 may be layers of a neural network. With each input 166, the low-resolution segmentation model 156 may generate a horizon probability output 174. The horizon probability output 174 may be a multi-dimensional (e.g., 2D) image indicating a probability or likelihood of a horizon existing at one or more depths corresponding to the subsurface ROI related to the input 166, i.e., the horizon probability output 174 may be in the form of a 2D probability map having a resolution. For example, a first input 166 may correspond to a first depth range and the probability mapping output 174 generated using the first input 166 may indicate a probability of a horizon existing at each depth within the first depth range. Further, a second input 166 may correspond to a second depth range and the probability mapping output 174 generated using the second input 166 may indicate a probability of a horizon existing at each depth within the second depth range. In this way, the low-resolution segmentation model 156 may generate the low-resolution horizon 162 that indicates an expected location (e.g., a depth or distance from a surface) and/or location range of a potential horizon.

Based on output of the low-resolution segmentation model 156, the site characterization system 120 may generate a low-resolution horizon 162, which may provide an indication of an expected location of an expected horizon in the seismic data 154. After generating the low-resolution horizon 162, the site characterization system 120 may apply a high-resolution regression model 158 to the low-resolution horizon 162 along with seismic data 176, which may be centered at the expected location of the horizon indicated in the low-resolution horizon 162, and a horizon label as a one-dimensional (1D) series 178. The high-resolution regression model 158 may also be a deep learning model and may be referred to as a second horizon deep learning model. In general, the centered seismic data 166 may include one or more portions of the seismic data 154 centered at (e.g., within a threshold range of) the expected locations of the potential horizons indicated by the low-resolution horizons 162. For example, the site characterization system 120 may apply the low-resolution horizon 162 as a mask to the seismic data 154 to generate a portion of the seismic data 154 where the likelihood of a horizon exceeds a threshold. In this way, a subset of the seismic data 154 (i.e., the centered seismic data 166) may be used by the high-resolution regression model 158 instead of the entire seismic data 154, thereby reducing the time and processing power used to train the high-resolution regression model 158.

As noted above, the probability mapping output 174 (i.e., the low-resolution horizon 162) may be a two-dimensional (2D) image that details the horizon label within the seismic data 154. The one-dimensional (1D) horizon label 178 represents the same horizon as described in the horizon label as mask 160 as 2D mask, but in a different data format to facilitate the computation within the high-resolution regression model 158. In other words, the first horizon label (i.e., horizon label as mask 160 as 2D mask) and the second horizon label (i.e., one-dimensional (1D) horizon label 178) may represent the same data; however, that same data may be formatted differently in the first and second horizon labels. In general, the 1D horizon label 178 may be a vector representative of the horizon in the seismic data 154, rather than a 2D mask, as described with respect to the probability mapping output 174 or horizon label as 2D mask 160. By representing as a vector, the site characterization system 120 may use the 1D horizon label 178 to determine a high-resolution horizon 152 using the high-resolution regression model 158, which may now employ regression techniques as opposed to segmentation techniques. The high-resolution horizon output 152 may include one or more specific horizon locations and has a resolution. Whether at the same time or alternatively, the high-resolution horizon output 152 or the one or more specific horizon locations may be a plurality of one-dimensional vector outputs representing horizon locations. The resolution of the one or more specific horizon locations may be greater than the resolution of the 2D probability map.

This is further illustrated in the inset 180. As illustrated, the probability mapping output 174 and an input 182 (e.g., an undecimated or unfiltered portion or packet of the seismic data 154) at a depth range corresponding the probability mapping output 174 may be provided to layers 184 and 186 of the high-resolution regression model 158. In turn, the high-resolution regression model 158 generates multiple 1D vector outputs 188 that represent horizons as output. Accordingly, the site characterization system 120 may use the high-resolution regression model 158 to yield a high-resolution horizon 152 having a resolution that is substantially similar to or the same as the original resolution of the seismic data 154 (e.g., prior to filtering). That is, the low-resolution horizon 162 may be used to process a portion of the unfiltered seismic data (e.g., seismic data 176) to identify horizons in a portion of the high-resolution seismic data 154 based on the horizon label as 1D series 178. In this way, the cascaded deep-learning techniques may generate horizon data at its original resolution (i.e., the high-resolution horizon 152) for identifying horizons 190 within the seismic data 154.

Indeed, the site characterization system 120 may use filtered seismic data 154 and the horizon label as 2D mask 160 to generate the low-resolution horizon 162 that may indicate the expected locations of the horizons in the filtered seismic data 154. Although the low-resolution horizon 162 may not include a high-resolution output view of the horizon, the site characterization system 120 may use the expected location or expected range of depths of the expected horizon to generate the high-resolution horizon 152 using the high-resolution regression model 158 applied to a portion of the high-resolution seismic data 154 that is centered at the expected location of the horizon as indicated by the low-resolution horizon 162. That is, the low-resolution horizon 162 may be used to identify a center line or portion of the original unfiltered seismic data 154 to analyze for determining the high-resolution regression model 158. As a result, the techniques described herein provide a computationally efficient manner to generate high-resolution seismic images representative of horizons in a subterranean region of the Earth.

Either or both the low-resolution horizon output 162 and the high-resolution horizon output 152 may be displayed to a user. Based on this displayed output(s), the user may select one or more worksite actions to be generated and transmitted via a signal that causes a physical action to occur at the worksite. Such actions may include one or more of generating a site characterization for the AOI, designating a site for construction of particular equipment, select a piling location, placing a piling at a selected location in the AOI and placing a piling foundation.

Referring now to FIG. 4, an alternative embodiment of the site characterization system 120 may receive seismic data 154 and a horizon label as two-dimensional (2D) mask 160 (e.g., across x-z plane) to apply to a low-resolution segmentation model 156. In general, the low-resolution segmentation model 156 may identify a low-resolution horizon 162 representing a probability or likelihood of a horizon being at one or more locations or depths within a subsurface region (e.g., including the rock layers 14). The low-resolution segmentation model 156 may be trained based on filtered seismic data 154 and the horizon label as 2D mask 160 to identify an expected location (e.g., a depth or distance from a surface) and/or location range of a potential horizon using the filtered seismic data 154, as described in more detail below. The site characterization system 120 may decimate or filter the seismic data 154 prior to applying the low-resolution segmentation model 156 to the seismic data 154. Decimating the seismic data 154 has been described previously, hereinabove. A result is that seismic data 154 may be filtered to produce lower resolution seismic data. The horizon label as mask 160 may include a relative index of the horizon. As such, the decimated seismic data 154 may still retain contextual information associated with the horizon label as mask 160 (e.g., the probability or likelihood of a horizon existing at a particular location within a subsurface ROI).

After receiving the seismic data 154 and the horizon label as a mask 160, the site characterization system 120 may train or generate the low-resolution segmentation model 156 using these inputs. The low-resolution segmentation model 156 may include a deep learning model and may be referred to as a first horizon deep learning model. The low-resolution segmentation model 156 may be a machine learning model.

Based on output of the low-resolution segmentation model 156, the site characterization system 120 may generate a low-resolution horizon 162, which may provide an indication of an expected location of an expected horizon in the seismic data 154. After generating the low-resolution horizon 162, the site characterization system 120 may apply a high-resolution segmentation model 157 to the low-resolution horizon 162 along with seismic data 176, which may be centered at the expected location of the horizon indicated in the low-resolution horizon 162. The high-resolution segmentation model 157 may also utilize the horizon label as 2D mask 160 and a horizon label as a one-dimensional (1D) series 178 as inputs. The high-resolution segmentation model 157 may be a deep learning model.

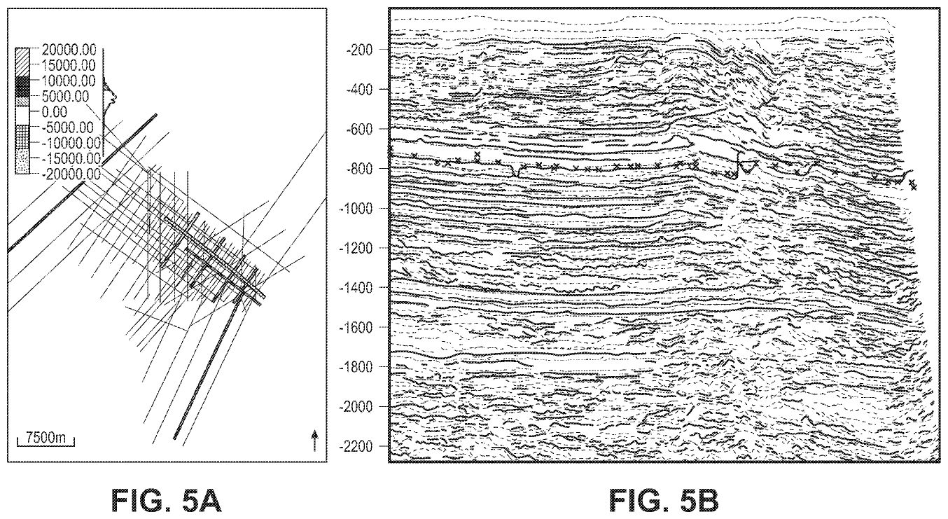

The centered seismic data 176 may include one or more portions of the seismic data 154 centered at (e.g., within a threshold range of) the expected locations of the potential horizons indicated by the low-resolution horizons 162. FIG. 5A illustrates an overhead plan view showing all 2D seismic lines within a geographic region with highlighted 2D seismic lines on which horizon labels used for training the deep learning models are available. FIG. 5B shows a horizon overlaid on a large cross section of a portion of an AOI displaying detailed seismic data. For example, the site characterization system 120 may apply the low-resolution horizon 162 as a mask to the seismic data 154 to generate a portion of the seismic data 154 where the likelihood of a horizon exceeds a threshold. In this way, a subset of the seismic data 154 such as the centered seismic data 176 may be used by the high-resolution segmentation model 157 instead of the entire seismic data 154, thereby reducing the time and processing power used to train the high-resolution segmentation model 157.

The low-resolution horizon 162 data, which may be in the form of a probability mapping output, may be a two-dimensional (2D) image that details the horizon label within the seismic data 154. The horizon label as 2D mask & 1D series 177 may represent the same horizon as described in the horizon label as mask 160, In the event that element 177 is only a 1D series, it still represents the same horizon as described in the horizon label as mask 160 but in a different data format to facilitate the computation within the high-resolution segmentation model 157. In general, the horizon label as 2D mask & 1D series 177 may be a vector representative of the horizon in the seismic data 154, rather than a 2D mask, as described with respect to the probability mapping output 174 or horizon label as 2D mask 160. By representing as a vector, the site characterization system 120 may use the 1D horizon label 178 to determine a high-resolution horizon 152 using the high-resolution classification model 157, which may now employ classification techniques as opposed to segmentation techniques. The high-resolution horizon output 152 may include one or more specific horizon locations and has a resolution. Whether at the same time or alternatively, the high-resolution horizon output 152 or the one or more specific horizon locations may be a plurality of one-dimensional vector outputs representing horizon locations. The resolution of the one or more specific horizon locations may be greater than the resolution of the 2D probability map.

This is further illustrated in the inset 200 of FIG. 4. As illustrated, input 183 may comprise one or more of the probability mapping output 162, the unfiltered seismic data 154, the seismic data centered at stage 1 prediction 176 and the horizon label as 2D mask & 1D series 177. This input 183 may be provided to residual block layer 185, ASPP blocks 171 and residual blocks 193. Alternatively, the ASPP blocks 171 may be skipped. These may be component neural network layers of high-resolution segmentation model 157. The output 194 of the high-resolution segmentation model 157 may be, or may be reshaped to, multiple 1D vector outputs 196 that represent horizons as output. Accordingly, the site characterization system 120 may use the high-resolution segmentation model 157 to yield a high-resolution horizon 152 having a resolution that is substantially similar to or the same as the original resolution of the seismic data 154 prior to filtering.

Thus, the low-resolution horizon 162 may be used to process a portion of the unfiltered seismic data 176 to identify horizons in a portion of the high-resolution seismic data 154 based on the horizon label as 2D mask & 1D series 177. In this way, the cascaded deep-learning techniques may generate horizon data at its original resolution (i.e., the high-resolution horizon 152) for identifying horizons 190 within the seismic data 154. As a result, the techniques described herein provide a computationally efficient manner to generate high-resolution seismic images representative of horizons in a subterranean region of the Earth.

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving unfiltered seismic data corresponding to a subsurface region of interest (ROI);
filtering the unfiltered seismic data to generate filtered seismic data;
retrieving a first horizon label as a two-dimensional (2D) mask;
training a first horizon deep learning model utilizing the filtered seismic data and the first horizon label as the 2D mask, wherein the first horizon deep learning model has a first output having a first resolution, and wherein the first output comprises a 2D probability map of an approximate location of one or more horizon picks; and
applying a second horizon deep learning model to a second horizon label as a one-dimensional (1D) mask and a portion of the unfiltered seismic data, wherein the portion of the unfiltered seismic data is within a threshold distance of the approximate location of the one or more horizon picks, and wherein the second horizon deep learning model has a second output that is one or more specific horizon locations having a second resolution.

2. The method of claim 1, further comprising displaying one or both of the first output and the second output.

3. The method of claim 1, further comprising performing a worksite action in response to one or both of the first output and the second output, wherein the worksite action comprises generating and transmitting a signal that causes a physical action to occur at the worksite that includes the subsurface ROI, and wherein the physical action includes selecting a specific worksite.

4. The method of claim 1, wherein the filtered seismic data is a vertically resampled version of the unfiltered seismic data for the ROI.

5. The method of claim 1, wherein the 1D mask and the 2D mask are received from a user or a data storage component.

6. The method of claim 1, wherein the first output is a 2D probability map of an approximate location of one or more horizon picks.

7. The method of claim 1, wherein the first and second horizon labels represent the same data, wherein the same data in the first and second horizontal labels is formatted differently.

8. The method of claim 1, wherein the second resolution is identical to a resolution of the unfiltered seismic data.

9. The method of claim 1, wherein the second output comprises a plurality of one-dimensional vector outputs representing horizon locations.

10. A computing system, comprising:
one or more processors; and
a memory system comprising one or more non-transitory computer-readable media storing instructions that, when executed by at least one of the one or more processors, cause the computing system to perform operations, the operations comprising:
receiving unfiltered seismic data corresponding to a subsurface region of interest (ROI);
filtering the unfiltered seismic data to generate filtered seismic data;
retrieving a first horizon label as a two-dimensional (2D) mask;
training a first horizon deep learning model utilizing the filtered seismic data and the first horizon label as 2D mask, wherein the trained first horizon deep learning model has a first output that is a 2D probability map having a first resolution, wherein the first output provides an approximate location of one or more horizon picks, and wherein the first horizon deep learning model is an image segmentation convolutional neural network; and
applying a second horizon deep learning model to a second horizon label as a one-dimensional (1D) mask and a portion of the unfiltered seismic data, wherein the first and second horizon labels represent the same data, wherein the same data in the first and second horizontal labels is formatted differently, wherein the portion of the unfiltered seismic data is within a threshold distance of the approximate location of the one or more horizon picks and further wherein the second horizon deep learning model has a second output that is one or more specific horizon locations having a second resolution.

11. The computing system of claim 10, wherein the operations further comprise:
displaying one or both of the first output and the second output; and
performing a worksite action in response to one or both of the first output and the second output, wherein the worksite action comprises generating and transmitting a signal that causes a physical action to occur at the worksite that includes the subsurface ROI, and wherein the physical action includes selecting a specific worksite.

12. The computing system of claim 10, wherein the second resolution is higher resolution than the first resolution and the second horizon deep learning model is one of a segmentation convolutional neural network and a regression convolutional neural network.

13. The computing system of claim 10, wherein the filtered seismic data is a vertically resampled version of the unfiltered seismic data for the ROI.

14. The computing system of claim 10, wherein the 2D mask is received from a user or a data storage component.

15. The computing system of claim 10, wherein the 1D mask is received from a user or a data storage component.

16. The computing system of claim 10, further comprising displaying the 2D probability map.

17. The computing system of claim 10, wherein the second resolution is identical to a resolution of the unfiltered seismic data.

18. The computing system of claim 10, wherein the output comprises a plurality of one-dimensional vector outputs representing horizon locations.

19. A non-transitory computer-readable medium storing instructions that, when executed by one or more processors of a computing system, cause the computing system to perform operations, the operations comprising:
receiving unfiltered seismic data corresponding to a subsurface region of interest (ROI);
filtering the unfiltered seismic data to generate filtered seismic data, wherein the filtered seismic data is a vertically resampled version of the unfiltered seismic data for the ROI;
retrieving a first horizon label as a two-dimensional (2D) mask from a user or a data storage component;
training a first horizon deep learning model utilizing the filtered seismic data and the first horizon label as 2D mask, wherein the trained first horizon deep learning model has a first output that is a 2D probability map having a first resolution, wherein the 2D probability map provides an approximate location of one or more horizon picks, wherein the first horizon deep learning model is an image segmentation convolutional neural network; and
retrieving a second horizon label as a one-dimensional (1D) mask from the user or data storage component, wherein the first and second horizon labels represent the same data, and wherein the same data in the first and second horizontal labels is formatted differently;
applying a second horizon deep learning model to the second horizon label as 1D mask and a portion of the unfiltered seismic data that is within a threshold distance of the approximate location of the one or more horizon picks, wherein the second horizon deep learning model has a second output that is one or more specific horizon locations having a second resolution, wherein the second resolution is higher resolution than the first resolution, wherein the second horizon deep learning model is one of a segmentation convolutional neural network and a regression convolutional neural network, wherein the second resolution is identical to an unfiltered seismic data resolution, and wherein the second output comprises a plurality of one-dimensional vector outputs representing horizon locations;
displaying one or both of the first output and the second output; and
performing a worksite action in response to one or both of the first output and the second output, wherein the worksite action comprises generating and transmitting a signal that causes a physical action to occur at the worksite that includes the subsurface ROI, and wherein the physical action includes selecting a specific worksite.

20. The non-transitory computer-readable medium of claim 19, wherein the second horizon deep learning model includes the segmentation convolutional neural network.
